(19) United States
(12) Patent Application Publication
(10) Pub. No.: US 2002/0191595 A1
(43) Pub. Date: Dec. 19, 2002

(54) Providing communications capabilities to mobile devices at an enterprise

(76) Inventors: Jack K. Mar, Richmond (CA); Stephen J. Williams, Port Coquitlam (CA); Ronald B. McLeod, Richmond (CA); Bradley Long, Richmond (CA); Ronald P. Linton, Bellingham, WA (US)

Correspondence Address: FENWICK & WEST LLP, TWO PALO ALTO SQUARE, PALO ALTO, CA, 94306, US

(21) Appl. No.: 10/172,576

(22) Filed: Jun. 13, 2002

Related U.S. Application Data
(60) Provisional application No. 60/299,658, filed on Jun. 18, 2001.

(51) Int. Cl. H04L 12/66; H04L 12/28; H04Q 7/24

(52) U.S. Cl. 370/352; 370/401; 370/338

(57) ABSTRACT

A softswitch at a network operations center (NOC) is in data communication with one or more enterprises. The softswitch performs call processing, mobility management, and media connection switching and signaling to provide communications capabilities including basic and enhanced calling features to mobile devices at the enterprises. The softswitch routes control signals for calls between the enterprises and the NOC, but routes call media on the most efficient point-to-point paths between the devices on the calls. This routing reduces the amount of bandwidth required between the enterprises and the NOC and provides economies of scale, thereby allowing a centralized NOC to efficiently support multiple enterprises. Each enterprise has an internet protocol (IP)-based network coupling one or more base station transceivers for providing coverage to the mobile devices. Each enterprise optionally has a media gateway connected to the IP network and a private branch exchange and/or public telephone network.

### CROSS-REFERENCE TO RELATED APPLICATION

This application claims the benefit of U.S. Provisional Application No. 60/299,658, filed Jun. 18, 2001, and incorporated herein by reference.

### BACKGROUND OF THE INVENTION

1. Field of the Invention

This invention pertains in general to enterprise communications systems and in particular to an enterprise communications system utilizing wireless communications technology.

2. Background Art

Typical employees of businesses or members of other enterprises often have multiple communications systems. For example, an employee might have a standard wired telephone in the employee's office for use as the primary telephone and a cellular telephone for use when the employee is “on the road.” The wired telephone is typically coupled to a Centrex system or another private branch exchange (PBX) that provides enhanced calling features to the wired telephones in the enterprise. These features may include the ability to call other wired telephones by dialing partial numbers, conference calling, call forwarding, voicemail, and access to outside lines.

Employees and other members of enterprises often desire to use the cellular telephone as the primary telephone. For example, employees who travel frequently find it convenient to use a cellular telephone at all times. However, it is not technologically or economically feasible to use the cellular telephone as the primary telephone in the enterprise.

A cellular telephone, in contrast to a wired telephone on a PBX, is typically connected to a macro-network, such as a state- or nation-wide communications network operated by a cellular telephone provider. When an employee utilizes the cellular telephone while in the employee's office, or elsewhere within the enterprise, the cellular telephone is treated as an outside line. Accordingly, the employee's cellular telephone lacks access to the enhanced calling features provided to the wired telephones in the enterprise by the PBX. Also, the cellular coverage within the enterprise provided by the macro-network is often not of sufficient quality for general use.

Moreover, the cost of using the cellular telephone as the primary telephone can be prohibitively expensive. Many cellular telephone providers charge cellular telephone users by the minute of use. As a result, an employee who frequently uses a telephone while at the enterprise is better off using the flat-fee wired telephone.

Therefore, there is a need for a way to allow employees and other members of enterprises to use cellular telephones as their primary telephones. Preferably, a solution to this need will provide the cellular telephones, or other wireless devices, with enterprise-level enhanced calling features and allow the enhanced calling features to bridge the wired and wireless networks at the enterprise. The solution will also preferably provide high-quality, and cost effective, coverage to cellular telephones within the enterprise.

### BRIEF SUMMARY OF THE INVENTION

The above need is met by a softswitch that provides communications capabilities to the mobile devices at the enterprise. Preferably, the softswitch is located in a network operations center (NOC) that serves multiple enterprises. The softswitch routes control signals for calls between the enterprises and the NOC, but routes call media (e.g., voice and data) on the most efficient point-to-point paths between the devices on the calls. This routing reduces the amount of bandwidth required between the enterprises and the NOC and provides economies of scale, thereby allowing a centralized NOC to efficiently support multiple enterprises.

In one embodiment, the NOC includes an IP network. An operations and maintenance console (OMC) on the IP network maintains subscriber profiles. A feature server (FS) on the IP network provides certain enhanced calling features to the mobile devices at the enterprises as specified by the subscriber profiles. A data serving node on the IP network allows the mobile devices to access servers on a public data network, such as the Internet. A media gateway on the IP network allows the mobile devices to access a public switched telephone network (PSTN) and a public land mobile network (PLMN). The softswitch is also on the IP network and controls the feature server, the data serving node, the media gateway, and a signaling gateway to provide call processing, media connection switching and signaling, and mobility management for the mobile devices.

An enterprise preferably includes an IP network in data communication with the NOC's IP network. The enterprise has one or more base transceiver stations (BTSs) that are coupled to the enterprise's IP network. The BTSs define a coverage area for the enterprise. Mobile devices within the enterprise's coverage area utilize the BTSs to communicate. The enterprise optionally has a local data serving node and/or media gateway coupled to its IP network. The media gateway may be coupled to the enterprise's private branch exchange (PBX).

Preferably, the softswitch interacts with the BTSs, data serving node, and media gateway to provide the mobile devices with enhanced calling features. Moreover, the mobile devices can use the enhanced features in calls with devices on the PBX and other external networks.

### BRIEF DESCRIPTION OF THE SEVERAL VIEWS OF THE DRAWING

FIG. 1 is a high-level block diagram illustrating a telecommunications system according to an embodiment of the present invention;

FIG. 2 is a high-level block diagram illustrating an embodiment of a telecommunications system having multiple network operation centers (NOCs);

FIG. 3 is a high-level block diagram illustrating the relationship between a NOC and an enterprise according to an embodiment of the present invention;

FIG. 4 is a high-level block diagram illustrating the communications interfaces between the devices illustrated in FIG. 3 according to an embodiment of the present invention;

FIG. 5 is a high-level block diagram illustrating the media flow paths in the system;

FIG. 6 is a ladder diagram further illustrating the media flow paths in the system;

FIG. 7 is a ladder diagram illustrating the functions performed by a softswitch to process a call originated by a mobile device associated with an enterprise according to an embodiment of the present invention;

FIG. 8 is a ladder diagram illustrating the steps performed by the softswitch to process a call initiated by a device on an external network and directed to a mobile device at an enterprise according to an embodiment of the present invention; and

FIG. 9 is a flow chart illustrating steps performed by the softswitch in combination with other devices in the NOC and/or enterprise to provide enterprise-level enhanced calling features according to an embodiment of the present invention.

The figures depict an embodiment of the present invention for purposes of illustration only. One skilled in the art will readily recognize from the following description that alternative embodiments of the structures and methods illustrated herein may be employed without departing from the principles of the invention described herein.

### DETAILED DESCRIPTION OF THE INVENTION

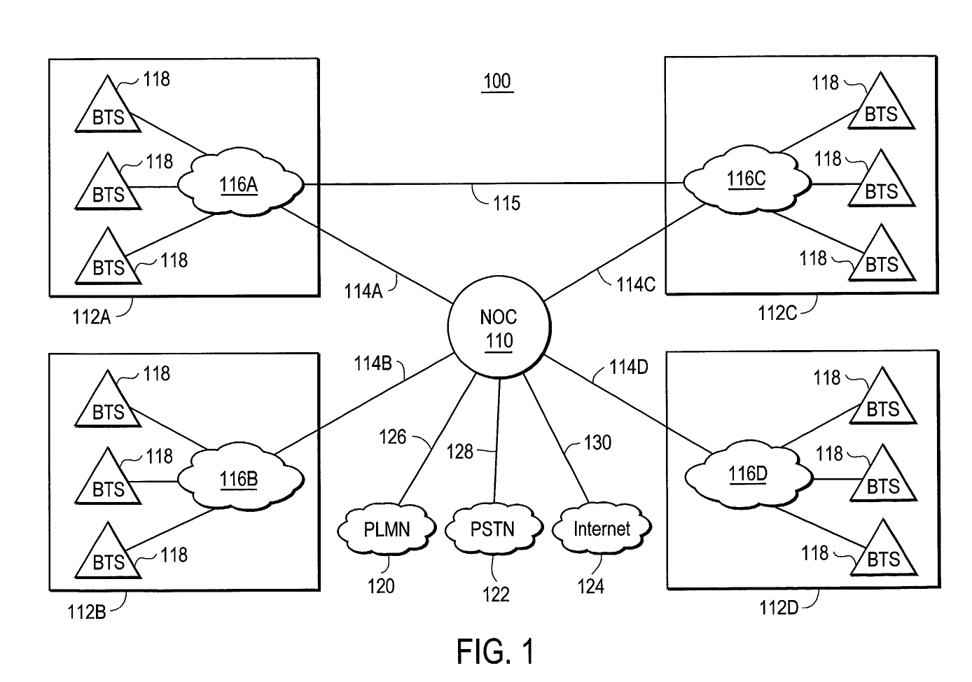

FIG. 1 is a high-level block diagram illustrating a telecommunications system 100 according to an embodiment of the present invention. In the figures, like elements are identified with like reference numerals. A letter after the reference numeral, such as “112A,” indicates that the text refers specifically to the element having that particular reference numeral. A reference numeral in the text without a following letter, such as “112,” refers to any or all of the elements in the figures bearing that reference number (e.g. “112” in the text refers to reference numerals “112A” and/or “112B” in the figures).

FIG. 1 illustrates a network operations center (NOC) 110 in communication with multiple remote enterprises 112 via communications links 114. In FIG. 1, four enterprises 112 are shown. However, it should be understood that the NOC 110 may be in communication with any practical number of enterprises. Depending upon the processing power of the NOC 110, the number of enterprises may vary, for example, from one to 100. For purposes of convenience and clarity, this description frequently refers to a single enterprise. This enterprise is merely representative of the one or more enterprises in communication with the NOC 110.

As used herein, an “enterprise” 112 is a business, governmental entity, nonprofit organization, family, or other entity having one or more geographic locations. Exemplary locations include office buildings or spaces within an office building, homes, warehouses, garages, blocks of a city, etc. A single enterprise 112 may include multiple discrete locations. Each of these locations can be treated as the same enterprise 112 or as different enterprises. The location of an enterprise 112 may expand, contract, or move over time. The enterprise 112 is said to be “remote” from the NOC 110, although there are no restrictions on the physical distance between the two entities.

The enterprise 112 preferably has an Internet Protocol (IP)-based data network 116 for supporting telecommunications services. This network 116 uses conventional networking technology, such as Ethernet, to route data within, and without, the enterprise 112. The enterprise 112 may also use the network 116 to provide Internet connectivity for the enterprise's computer systems. Preferably, a communications link 114 connects the network 116 to the NOC 110. The communications link 114 preferably uses conventional networking technologies such as asynchronous transfer mode (ATM) circuits and may be a dedicated link or utilize a shared link such as one traveling over the Internet 124. The communications link 114 allows devices on the enterprise's network 116 to communicate with the NOC 110 via conventional communications protocols, such as the transmission control protocol/internet protocol (TCP/IP).

The enterprise 112 has an optional direct communications link 115 connecting its network 116 to the network of another enterprise (or another network of the same enterprise). This direct communications link 115 may be part of a wide-area network, a dedicated communications link, a secure link passing over the Internet 124, etc. and preferably uses conventional communications technology. The direct communications link 115 may be used, for example, to bridge networks of an enterprise having multiple locations.

The enterprise 112 has one or more base transceiver stations (BTS) 118. Preferably, the BTSs 118 are IP-based and are coupled to the enterprise's network 116. Each BTS 118 preferably provides radio frequency (RF) coverage for a geographic area, although in alternative embodiments one or more of the BTSs may support additional wireless communications technologies, such as infra-red. Multiple BTSs 118 may be used in proximity with each other to provide uniform RF coverage for an area. Accordingly, the enterprise 112 may have any practical number of BTSs 118, depending upon the size of the desired coverage area. For purposes of convenience and clarity, each enterprise 112 in FIG. 1 is illustrated as having three BTSs 118.

In a preferred embodiment, the BTSs 118 communicate with cellular telephones and other suitably-enabled mobile devices 322 in their respective coverage areas. The BTSs 118 allow voice and data to be communicated among the mobile devices 322 and other devices on the IP-based network 116, and, by extension, devices on the NOC 110.

Each mobile device 322 is preferably associated with a “subscriber.” Each subscriber, in turn, is preferably associated with a particular enterprise 112. Preferably, a subscriber's mobile device 322 is configured to communicate with the enterprise's BTSs 118 when within the enterprise's coverage area. When a subscriber's mobile device 322 is outside of the enterprise's coverage area, the device preferably communicates with a macro wireless network, such as a cellular telephone network operated by a nationwide service provider.

In addition to the enterprises 112, the NOC 110 is preferably in communication with a public land mobile network (PLMN) 120, a public switched telephone network (PSTN) 122, and the Internet 124 via communications links 126, 128, and 130, respectively. The PLMN 120 is preferably a cellular telephone network operated by a cellular telephone service provider, such as AT&T, SPRINT, CINGULAR, etc. The PSTN 122 is preferably a conventional wired telephone network. The Internet 124 is preferably the conventional Internet.

The NOC 110 preferably interacts with the devices on the enterprises' networks 116 to provide enhanced calling features to mobile devices 322 used by the enterprises' subscribers. The NOC 110 may also manage interfaces between the enterprise' wireless and wired networks, thereby allowing the enhanced calling services to span both networks. In addition, the NOC's connections with the PLMN 120, PSTN 122, and Internet 124 allow the NOC 110 to provide the mobile devices 322 with traditional mobility services, such as roaming, calling devices on other networks, and sending and receiving data via the Internet.

The NOC 110 preferably logically partitions subscribers of different enterprises 112, and provides each enterprise with separate network and subscriber management capabilities. Accordingly, some or all subscribers at a first enterprise may be able to access enhanced calling features or other services provided by the NOC 110 that are inaccessible to subscribers at a second enterprise. For example, some subscribers at the first enterprise may have long distance service access via a first telecommunications provider, other subscribers at the first enterprise may not have any long distance access, while subscribers at the second enterprise may have long distance access via a second telecommunications provider. Preferably, the NOC 110 provides this functionality by allowing subscribes to be assigned to one or more hierarchical groups, and then assigning certain rights and privileges to the groups. Any rights and privileges assigned to a group are automatically inherited by all descendents of that group.

In a preferred embodiment, the BTSs 118 route control signals to the NOC 110, but route call media (e.g., voice and data traffic) flows point-to-point between the devices on the call. Only media flows destined for outside the enterprise 112 leave the enterprise. This routing reduces the amount of bandwidth required on the links 114 between the enterprises 112 and the NOC 110 and/or on the link 115 between the enterprises, and reduces the amount of data processing performed by the NOC when supporting multiple enterprises. In one embodiment, a single, centralized NOC 110 can support multiple enterprises 112 and approximately 1,000,000 subscribers, thereby realizing significant economies of scales and allowing the NOC operator to offer the enterprises cost-effective telecommunications solutions. In addition, the centralized NOC 110 minimizes the number of connection points with the PSTN 122 and PLMN 120. These connection points are often costly and difficult to implement and, therefore, there is a significant benefit in reducing the number of these connections.

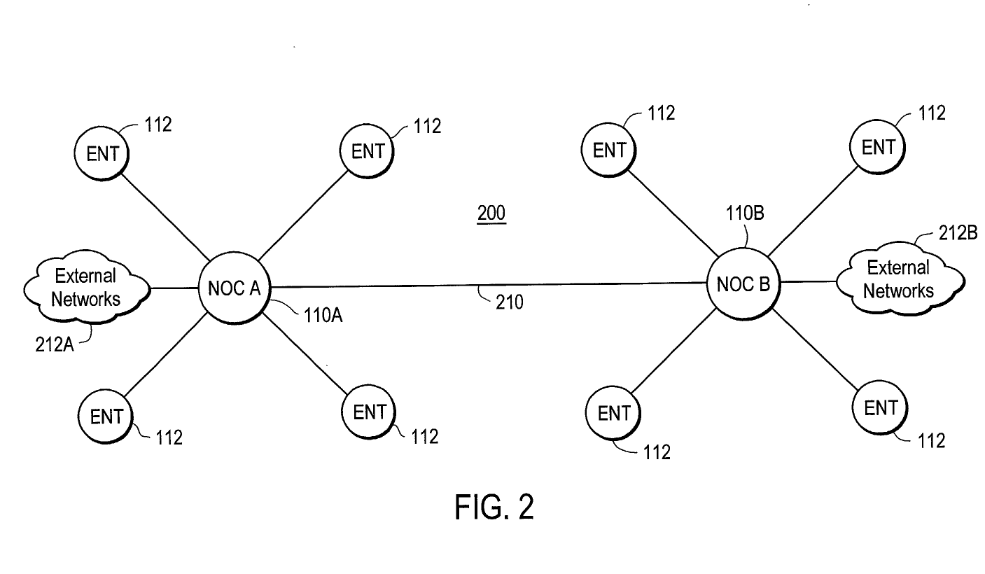

FIG. 2 is a high-level block diagram illustrating an embodiment of a telecommunications system 200 having multiple NOCs 110. Although only two NOCs 110A, 110B are illustrated in FIG. 2, embodiments of the system 200 may have any practical number of NOCs. In one embodiment, each NOC 110 serves enterprises in a different geographical area, although in some embodiments multiple NOCs may be utilized to serve enterprises in a single area or the relationship between NOCs and enterprises may not be based on geography. In the illustrated environment 200, the first NOC 110A is connected to four enterprises 112 and the second NOC 110B is connected to four other enterprises 112. As with the embodiment of FIG. 1, each NOC 110 can be connected to any practical number of different enterprises 112. The NOCs 110 are connected to each other via a communications link 210, thereby forming a wide area network. In one embodiment, this link 210 is a dedicated link using conventional networking technologies. Depending upon the embodiment, the link 210 between the NOCs may pass over a public network such as the Internet 124. Each NOC 110 is optionally connected to one or more external networks 212. In one embodiment, the external networks 212 include the PLMN 120, PSTN 122, and the Internet 124 as illustrated in FIG. 1.

An advantage of the embodiment having multiple networked NOCs 110 is that enterprises 112 having multiple disparate facilities can connect each facility to a local NOC. The communications link 210 between the NOCs 110 allows the NOCs to support the enterprise as if each facility were connected to the same NOC. Thus, an enterprise 112 can have nationwide coverage through linked NOCs 110. In addition, efficient long-distance communications can be achieved by routing calls through the wide area network of NOCs 110 instead of the PSTN 122 or PLMN 120 (e.g., “last-mile hop-off' or “PSTN bypass”). Other advantages of multiple networked NOCs 110 will be apparent to those of skill in the art.

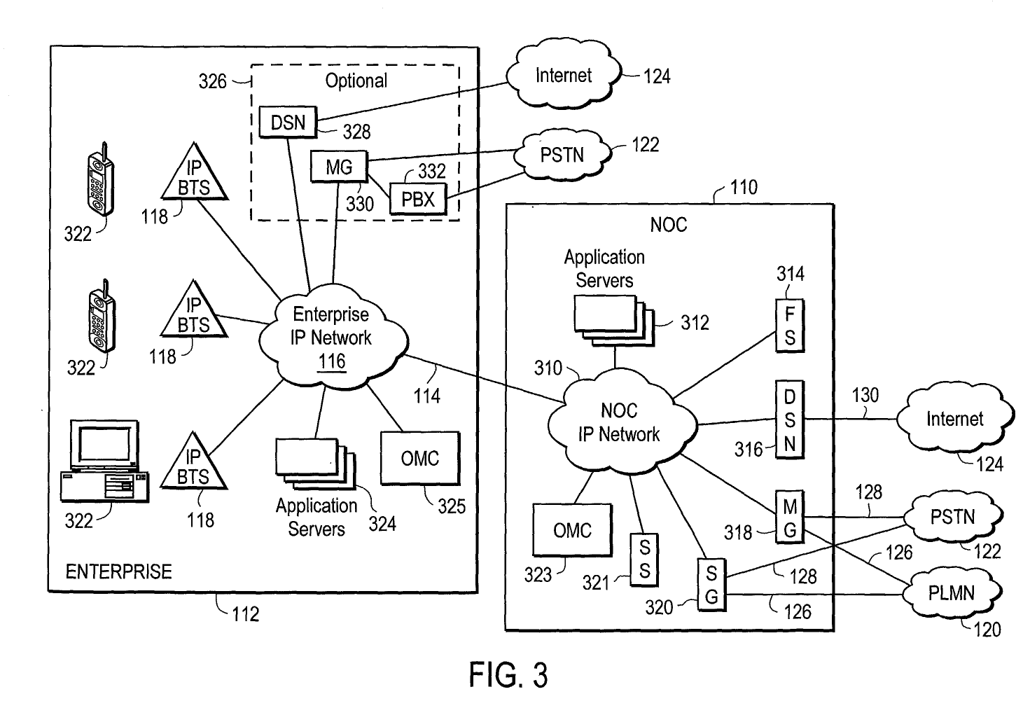

FIG. 3 is a high-level block diagram illustrating the relationship between a NOC 110 and an enterprise 112 according to an embodiment of the present invention. FIG. 3 also shows additional internal details of the NOC 110 and enterprise 112. The NOC 110 is preferably implemented with a conventional computer hardware having carrier-grade redundancy and fault tolerance. The functionality of the various devices in the NOC 110 (and the enterprise 112) is preferably provided by one or more computer program modules. As used herein, the term “module” refers to computer program logic and/or any hardware or circuitry utilized to provide the functionality attributed to the module. Thus, a module can be implemented in hardware, firmware, and/or software.

The NOC 110 preferably includes an IP data network 310 utilizing conventional networking technology. The network 310 allows the various devices in the NOC 110 to communicate, and allows the NOC 310 to communicate with the enterprise 112 via the communications link 114. In one embodiment, one or more application servers 312 are connected to the network 310 in the NOC 110. The application servers 312 preferably store and execute one or more application programs for providing enhanced functionality to the mobile devices 322 at the enterprise 112. For example, the applications servers 312 may store and execute wireless application protocol (WAP) applications for providing information and functionality to WAP-enabled mobile devices. These applications may enable the mobile devices 322 to receive stock quotes and weather information, trade securities, and/or perform other functions. While in certain embodiments the application servers may be located on the Internet 124 rather than at the NOC 310, some applications execute more efficiently and/or effectively from a point closer to the enterprise 112. For example, applications executing at the NOC 110 will generally provide faster response times than applications executing on the Internet 124. Therefore, classes of applications requiring fast response times will benefit from being located on the application servers 312 at the NOC 110.

A feature server (FS) 314 is preferably connected to the network 310 in the NOC 110. The FS 314 provides enhanced calling features to the enterprise 112. In some embodiments of the present invention, enhanced calling features are provided by other devices in the NOC 110 instead of, or in addition to, the FS 314. For example, functionality for providing frequently utilized enhanced calling features may be built directly into the softswitch 321.

As used herein, the phrase “enhanced calling features” refers to features beyond basic telephone functionality. Exemplary enhanced calling features include partial-number dialing, toll calling, call forwarding and transferring, conference calling, line camping, customized treatment depending upon the calling or called party, customized billing applications providing specialized billing reports for the enterprise, number portability wherein a subscriber keeps the same telephone number when moving among the enterprises, reverse 911 features allowing an emergency operator can locate a subscriber and/or call subscribers at an enterprise when there is an emergency, etc.

Other exemplary enhanced calling features include concurrent and sequential ringing. For concurrent ringing, a subscriber specifies multiple devices that “ring” simultaneously in response to a call to one of the devices. The call is then routed to the first device that is answered. For example, a subscriber can use concurrent ringing to specify that both a mobile device 322 and a device on the enterprise's PBX 332 should ring in response to a call to either device. For sequential ringing, a subscriber specifies multiple devices that “ring” in a pre-established order. For example, a subscriber can use sequential ringing to specify that the PBX device should ring first, then the mobile device 322 should ring, and then the subscriber's home telephone (located on the PSTN 122) should ring. Preferably, a subscriber can combine the concurrent and sequential ringing features to establish a desired ringing configuration.

Alternative embodiments of the present invention may offer other enhanced calling features in addition to, or instead of, those described herein. In one embodiment, the FS 314 also provides a service creation environment (SCE) that allows developers associated with the NOC 110 and/or enterprise 112 to develop custom calling features.

A data serving node (DSN) 316 is preferably connected to the network 310 and the Internet 124. The DSN 316 supports and provides communications between servers on the Internet 124 and the mobile devices 322 at the enterprise 112 by mapping data to the appropriate inbound/outbound locations. Although not shown in FIG. 3, the DSN 316 may be connected to other private or public networks in addition to, or instead of, the Internet 124. Such other networks may include, for example, an intranet operated by the enterprise 112 and a virtual private network (VPN). These communications enable WAP, short message service (SMS), multimedia messaging service (MMS), and other web-enabled features on the mobile devices. The particular hardware and/or functionality provided by the DSN 316 depends upon the technology utilized by the mobile devices 322. If the mobile devices 322 utilize the Code Division Multiple Access (CDMA) standard, the DSN 316 preferably includes a packet data serving node (PDSN). Similarly, if the mobile devices utilize the Global System for Mobile Communications (GSM) standard or the Universal Mobile Telecommunications System (UMTS) standard, the DSN 316 preferably includes a serving general packet radio service (GPRS) support node (SGSN).

A media gateway (MG) 318 is preferably connected to the network 310. The MG 318 serves to couple the NOC 110 to the PLMN 120 and the PSTN 122. As such, a primary function of the MG 318 is to convert media data (e.g., voice data) among the formats utilized by the enterprise's 116 and NOC's networks 310 and the formats utilized by the PLMN 120 and PSTN 122. Preferably, the media data on the networks are encoded in an IP-based representation and transmitted via the real-time protocol (RTP). However, the underlying format of the media is preferably the native format of the mobile device 322 on the call. Depending upon the mobile device 322, the native formats can be enhanced variable rate coding (EVRC), QualComm excited linear predictive (QCELP) coding, full rate (FR) coding, enhanced FR (EFR) coding, voice over IP (VoIP) coding, adaptive multi rate (AMR) coding, etc. The PLMN 120 typically also utilizes one or more of these formats to transmit the media. The PSTN 122 typically utilizes pulse code modulation (PCM) coding.

A signaling gateway (SG) 320 is preferably connected to the network 310 and is also connected to the PLMN 120 and PSTN 122. The SG 320 performs media connection signaling to support calls between the mobile devices 322 at the enterprise and devices on the PLMN 120 and PSTN 122. The SG 320 also preferably handles signaling for providing mobility management for the mobile devices 322.

A softswitch (SS) 321 is preferably connected to the network 310. The SS 321 preferably controls the operation of the NOC 110 and, by extension, controls the operation of the entire telecommunications system 100 to provide communications capabilities to the mobile devices 322 at the enterprises 112. As part of this role, the SS 321 provides call processing and controls media connection switching and signaling for the mobile devices 322. The SS 321 also preferably enforces the logical partitioning of subscribers to enterprises and the subscribers' rights and privileges as specified in the subscribers' profiles.

The SS 321 also preferably provides mobility management for the mobile devices 322 associated with the subscribers. The mobility management enables roaming capabilities. That is, mobility management allows the mobile devices to receive service as they move among the enterprise 112 and external coverage areas (e.g., other coverage areas on the PLMN 120). The SS 321 preferably provides mobility management by supporting home location register (HLR) functionality (or, in the case of UMTS networks, home subscriber server (HSS) functionality). A HLR is a storage location that holds information about a given subscriber that the SS 321 and devices on the PLMN 120 use to authorize and provide services to the subscriber. Preferably, information for any given subscriber is kept in only one HLR. The SS 321 and devices on the PLMN 120 use either the IS-41 network (for CDMA systems) or GSM MAP network (for GSM systems) to access the HLR.

In one embodiment, the NOC 110 maintains a HLR for at least some of the subscribers associated with the enterprises 112 and makes the HLR accessible to the PLMN 120. In another embodiment, the HLRs for at least some of the subscribers are maintained on the PLMN 120 by the macro network providers and the NOC 110 accesses the HLRs to authorize and provide services to the subscribers at the enterprises.

The mobility management capabilities of the SS 321 allow it to control the subscribers' access to the enterprises' and external coverage areas. For example, the SS 321 can grant or deny service to a foreign mobile device within an enterprise's coverage area. Similarly, the SS 321 can control whether a mobile device 322 associated with an enterprise 112 gets service on the macro network. Thus, the SS 321 can enable mobile devices 322 that receive service only when the devices are within an enterprise's coverage area.

The mobility management capabilities of the SS 321 also include handoff (referred to as “handover” in GSM terminology). “Handoff” is the ability to keep an active call connected and functioning when a mobile device 322 on the call moves from one network to another (e.g., from an enterprise network to a macro network). The SS 321 also preferably uses its mobility management capabilities to enable location-based services to the mobile devices 322. In sum, the mobility management capabilities of the SS 321 generally allow a subscriber to use a mobile device 322 in the normal manner.

The NOC 110 preferably includes an operations and maintenance console (OMC) 323 coupled to the network 310. The OMC 323 is used by an administrator to interface with the SS 321 and other devices in the telecommunication system 100 to control and supervise the system. The OMC 323 is the logical equivalent of a control console for each device in the system 100 and allows the administrator to specify and control available features, create and maintain subscriber profiles, configure the BTSs at the enterprises 112, review usage and billing records, perform maintenance, etc. The OMC 323 also preferably stores the subscriber profiles. The subscriber profiles preferably contain information identifying the subscribers, identifying the enterprises with which the subscribers are associated, and describing the applications and features (i.e., rights and privileges) available to the subscribers.

Turning now to the enterprise 112, the enterprise's IP network 116 is connected to the NOC's network 310 via the communications link 114. Preferably, the enterprise network 116 includes quality of service (QoS) functionality in order to provide predictable throughput during periods of network congestion. More specifically, the QoS functionality allows the network 116 to guarantee that the devices related to the telecommunications system (e.g., the BTSs 118 and communications link 114) will receive at least a specified minimum bandwidth even when the network is otherwise congested. The enterprise IP network 116 may also lack QoS functionality. In this case, it is preferable, but not necessary, to “overbuild” the network 116 to reduce the chance of network congestion, or to provide a network dedicated to the telecommunications system 100.

As described above, multiple BTSs 118 are preferably coupled to the enterprise's network 116. The BTSs 118 are preferably relatively small and low-powered. In one embodiment, a typical BTS 118 outputs approximately 10 to 100 milliwatts of power, which provides a usable signal over approximately a 100-foot radius and may encompass a few dozen subscribers. However, the BTSs 118 can also be higher-powered and serve larger coverage areas. For example, a BTS 118 utilized in an outdoor environment may support a greater range and number of subscribers than a BTS utilized in an indoor office environment.

Each BTS 118 can serve one or more cells in a cellular network defined by the NOC 110. The BTSs 118 preferably convert RF signals received from the mobile devices 322 into IP packets for transmission on the network 116 via the RTP. The BTSs 118 also correspondingly convert IP packets received from the network 116 into the appropriate formats for the mobile devices 332 and broadcast corresponding RF signals.

In one embodiment, each BTS 118 includes a controller and associated memory (not shown) for controlling the processing performed by the BTS, sending and receiving packets on the network 116, and storing configuration data. The BTSs 118 are preferably controlled directly by the SS 321. In addition, the BTSs 118 are preferably initialized and configured by the OMC 323, 325 and SS 321. Since the BTSs 118 require no on-site configuration, the enterprise 112 can increase capacity simply by adding additional BTSs to its existing IP network 116. The enterprise 112 does not need to provision dedicated circuits, run new cabling, or upgrade its existing equipment. This modular approach allows for quick installation and expansion.

The IP BTSs 118 are illustrated in proximity to three mobile devices 322. The mobile devices are all identified with reference numeral 322 to indicate that the devices are functionally identical for purposes of this description. In reality, however, the devices 322 may be different and/or support different feature sets. As used herein, the term “mobile device” covers all devices that may be in communication with the BTSs 118, regardless of whether a particular device is typically or actually “mobile.” In addition to cellular telephones, mobile devices 322 may include personal digital assistants (PDAs), laptop or desktop computers having modules for supporting wireless communications, non-cellular wireless telephones, etc. Each mobile device 322 is preferably associated with at least one subscriber.

In one embodiment, the functionality of a BTS 118 and a mobile device 322 is provided by a single wired or wireless device. For example, an IP-based telephone or Internet access device (IAD) can be coupled directly to the enterprise's IP network 116 and controlled by the NOC 110 in the same manner as a mobile device 322 operated through a BTS 118. Since these types of integrated devices are functionally equivalent to a BTS 118 and mobile device 322, the terms “BTS” and “mobile device” are intended to cover such devices.

The BTSs 118 and mobile devices 322 may support and/or communicate using one or more of a variety of wireless technologies, depending upon the embodiment. One embodiment of the present invention supports the CDMA, GSM, UMTS, 802.11 technologies, the Bluetooth wireless networking specification, and/or variants thereof. Alternative embodiments may support other technologies in addition to, or instead of, the technologies described herein.

One or more enterprise-level application servers 324 are preferably connected to the enterprise network 116. These application servers 324 are preferably functionally-equivalent to the application servers 312 at the NOC 110. Certain classes of applications, such as enterprise-specific applications, are more effectively executed on application servers 324 at the enterprise 112.

The enterprise 112 preferably includes an OMC 325 coupled to the network 116. This OMC 325 is preferably similar to the OMC 323 at the NOC 110, except that the enterprise's OMC allows an administrator to control and supervise only the aspects of the system that relate to the enterprise 112. In one embodiment, the enterprise OMC 325 allows an administrator assign rights and privileges at the subscriber, enterprise, and public levels. The OMC 325 also preferably allows the administrator to define groups of subscribers associated with the enterprise 112, and then assign rights and privileges to the groups. In one embodiment, the enterprise OMC 325 is implemented with a computer system having a web browser client. The administrator uses the web browser to access the OMC 323 at the NOC 110 and obtain web pages allowing the administrator to control and supervise the enterprise's network 116.

A dashed line 326 surrounds several optional components that may be present in the enterprise 112, specifically, a DSN 328, a MG 330, and a PBX 332. The optional DSN 328 is preferably connected to the network 116 and the Internet 124 and supports and provides communications between servers on the Internet 124 and the mobile devices 322.

The optional MG 330 is preferably connected to the network 116, the PSTN 122, and the enterprise's PBX 332 (if present). In alternative embodiments, the MG 330 may be connected to only the PBX 332 or PSTN 122, and/or may be connected to the PLMN 120. The MG 330 in the enterprise 112 essentially serves the same function as the MG 318 in the NOC 110, except that the enterprise's MG 330 also interfaces with the PBX 332. The MG 330 in the enterprise may also provide signaling functionality.

The PBX 332 is connected to the PSTN 122. The PBX 332 is typically a wired communications system operated by the enterprise 112 in combination with a telecommunications service provider, such as the company or companies operating the PSTN 122. The PBX 332 provides enhanced calling services for the users of telephones and other communications devices coupled to the PBX.

Preferably, the MG 330 in the enterprise 112 serves as a bridge between the telephones on the PBX 332 and the mobile devices 322 on the IP network 116. Thus, the MG 330 provides an interface allowing calls between mobile devices 322 and telephones on the PBX 332 to communicate without utilizing the PLMN 120 or PSTN 122. In addition, the MG 330 allows the NOC 110 to provide advanced calling features that extend across both the mobile device and PBX networks, such as allowing shortened dialing, concurrent and sequential ringing, forwarding, conferencing, transferring, camping, etc.

Embodiments of the present invention may lack one or more of the devices illustrated in FIG. 3 and/or have devices not shown therein. Since the devices in the NOC 110 and enterprise 116 are each coupled to local IP networks 116, 310, which in turn are joined by a communications link 114, data can easily be shared among the devices in the NOC and/or enterprise. This sharing allows the functionality of the devices to be allocated differently than described herein by combining or distributing functions among the devices in different manners.

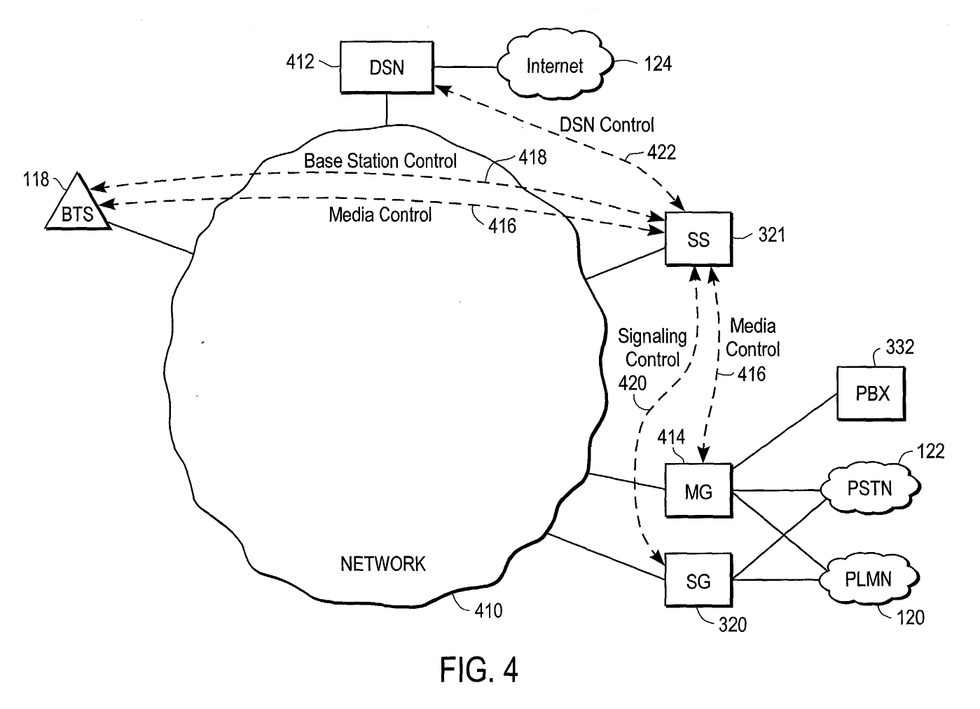

FIG. 4 is a high-level block diagram illustrating the communications interfaces between the devices illustrated in FIG. 3 according to an embodiment of the present invention. FIG. 4 illustrates an IP network 410 representative of the network provided by the enterprise IP network 116, communications link 114, and NOC IP network 310, a DSN 412 representative of the enterprise and/or NOC DSNs 326, 328, and a MG 414 representative of the enterprise and/or NOC MGs 318, 330. Similarly, the illustrated BTS 118 is representative of the one or more BTSs at the enterprise 112.

The dashed lines in FIG. 4 represent the control interfaces over the IP network 410 according to a preferred embodiment of the present invention. The control interfaces all converge at the SS 321 since the SS is preferably the primary control element for the system 100.

The SS 321 preferably has respective media control interfaces 416 with the BTS 118 and MG 414. The SS 321 uses the media control interfaces 416 to establish and control the media path(s) between the parties on a call. In one embodiment, the protocols used on the media control interfaces 416 include the media gateway control protocol (MGCP), the ITU-T Recommendation H.248 protocol, the session initiation protocol (SIP), and the Bearer-Independent Call Control (BICC) protocol.

The SS 321 preferably interfaces with the BTS 118 through a base station control interface 418. The SS 321 uses this interface 418 to control the operation and configuration of the BTS 118. Depending upon the technology utilized by the mobile device 322 and BTS 118, the base station control interface may be the interoperability specification (IOS) interface, the GSM “A” interface, the Iu-CS interface, and/or another interface. In a preferred embodiment of the present invention, the SS 321 uses the SCCP LITE protocol available from TELOS Technology, Inc. to exchange control messages with the BTS 118 over the interface 418 via the IP. Other embodiments use protocols in the signaling transport (SIGTRAN) suite to control the BTS 118.

The SS 321 preferably uses a signaling control interface 420 to communicate with and control the operation of the SG 320. The SS 321 uses the SIGTRAN Stream Control Transmission Protocol (SCTP) to exchange control messages with the SG 320. The SS 321 preferably interfaces with the DSN 412 through a DSN control interface 422 and uses SIGTRAN protocols to exchange control messages with the DSN.

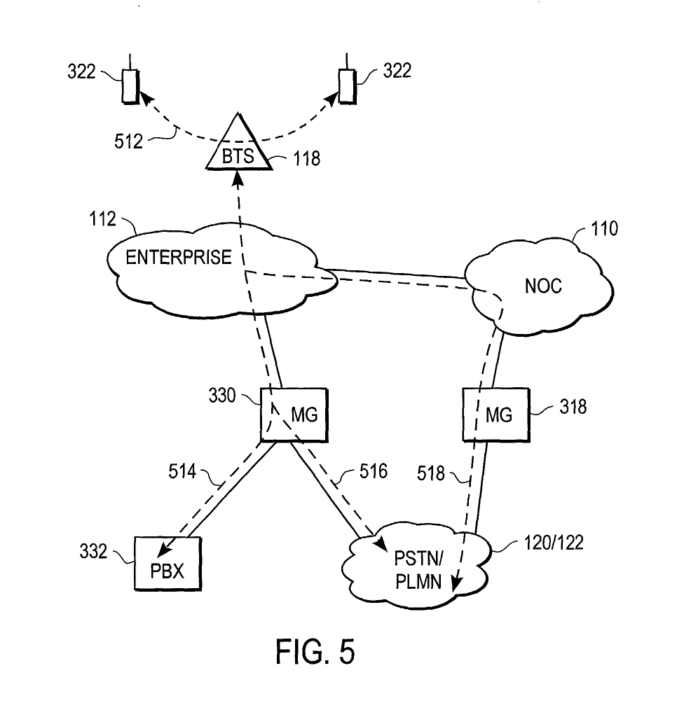

FIG. 5 is a high-level block diagram illustrating the media flow paths in the system 100. FIG. 5 illustrates two mobile devices 322A, 322B in communication with a BTS 118 at an enterprise 112. The enterprise 112 includes a MG 330 in communication with a PBX 332 and the PSTN 122. The enterprise 112 is in communication with a NOC 110 which, in turn, has a MG 318 in communication with the PSTN 122 and PLMN 120. The dashed lines in FIG. 5 represent possible media flow paths between the two mobile devices 322 and between one of the mobile devices and the PBX 332, PSTN 122, and/or PLMN 120. These paths travel across the networks and/or communications links described above and are established by the SS 321 through the media control interfaces 416.

If a call originates and terminates with mobile devices 322 at the enterprise 112, the SS 321 preferably routes the media flow on a path directly between the BTS(s) 118 serving the mobile devices. In FIG. 5, this media flow path is represented by dashed line 512. If a call is between a mobile device 322 at the enterprise 112 and a device on the enterprise's PBX 332, the SS 321 preferably routes the media flow on a path between the BTS 118 serving the mobile device and the enterprise's MG 330. FIG. 5 represents the media flow between the mobile device 322 and the PBX 332 with dashed line 514.

The media flow path for a call between a mobile device 322 at the enterprise 112 and a device on the PSTN 510 depends upon whether the enterprise has a MG 330. If the enterprise 112 has a MG 330, the media preferably flows between the BTS 118 serving the mobile device 322, the enterprise's MG 330, and the PSTN 510. This path is represented in FIG. 5 by dashed line 516. If the enterprise 112 lacks a MG 330, the media preferably flows between the BTS 118 serving the mobile device 322, the NOC's MG 318, and the PSTN 510. This latter path is represented in FIG. 5 by dashed line 518.

The media path for a call between a mobile device 322 at the enterprise 112 and a device on the PLMN 510 preferably flows between the BTS 118 serving the mobile device, the MG 318 at the NOC 110, and the PLMN 510. In FIG. 5, this path is represented by dashed line 518.

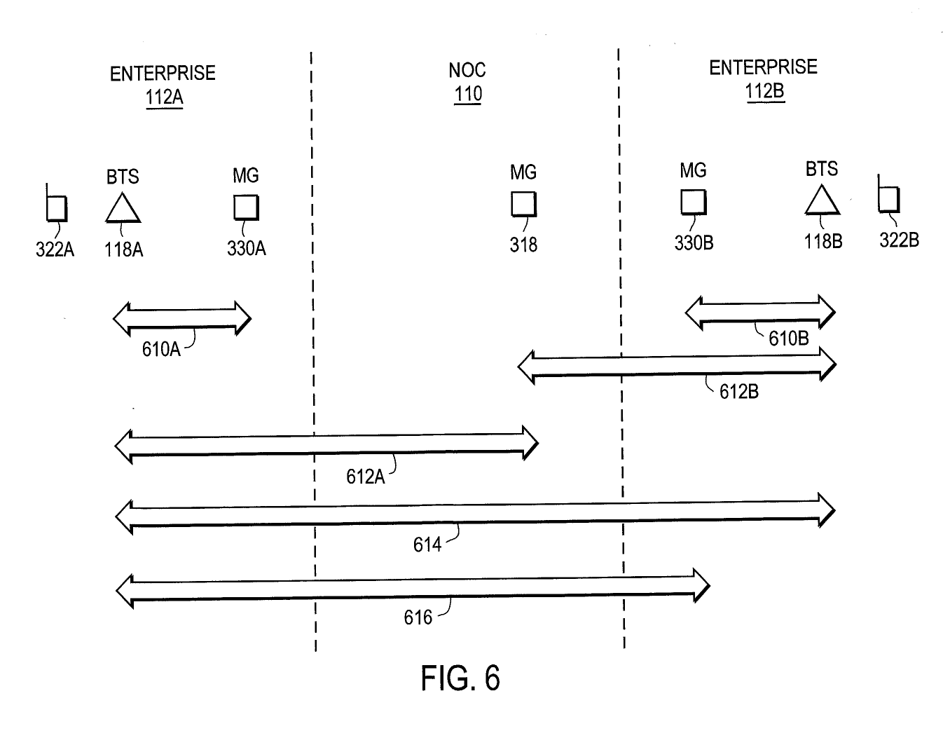

FIG. 6 is a ladder diagram further illustrating the media flow paths in the system 100. Starting from the top-left, FIG. 6 illustrates a first enterprise 112A, a NOC 110, and a second enterprise 112B. Each enterprise 112 contains a BTS 118 serving a mobile device and an optional MG 330. The NOC 110 contains a MG 318. FIG. 6 also illustrates arrows below the entities of the enterprises 112 and NOC 110 and aligned to illustrate the media flow paths established by the SS 321.

If an enterprise 112 has a MG 330, and a call is made between a mobile device 322 and a device on the PBX 332 or PSTN 122, the SS 321 preferably routes the media flow on a path between the enterprise's BTS 118 serving the mobile device and the MG 330. Arrows 610A and 610B illustrate these media paths for the two enterprises 112. If an enterprise 112 lacks a MG 330, and/or the call is to a device on the PLMN 122, the SS 321 preferably routes the media flow for the call on a path between the enterprise's BTS 118 and the MG 318 in the NOC 110, as illustrated by arrows 612A and 612B.

In addition, if the call is between a mobile device at the first enterprise 112A and a mobile device at the second enterprise 112B, and there is a direct communications link 115 between the enterprises, the SS 321 preferably routes the media flow on a path over the direct link. Arrow 614 illustrates this path. If the call is between a mobile device at a first enterprise 112A and a device on a PBX at a second enterprise 112B, and there is a direct communications link 115 between the enterprises, the SS 321 preferably routes the media flow on a path from the BTS 118A at the first enterprise, over the direct link 115, to the MG 330B at the second enterprise. Arrow 616 illustrates this path. Other variations and possible paths will be apparent to one of skill in the art.

Accordingly, the SS 321 preferably routes media flow on the most efficient and direct path(s) between the devices on the call. This direct routing is called “point-to-point.” If two devices on the call are mobile devices 322 at an enterprise (or at two enterprises joined by a direct link 115), the SS preferably routes the media flow on a path directly between the BTS(s) 118 serving the mobile devices. If only one device on the call is a mobile device 322, the SS 321 preferably routes the media flow on a path directly between the BTS 118 serving the mobile device and the network ingress/egress point (i.e., MG or DSN) behind which the other device(s) on the call is located. This routing is called “point-to-point” even though the media may pass through one or more other routers or servers due to the nature of the IP networks 116, 310 transmitting the media. The exact routing may depend upon factors including the number of devices on the call, any network congestion, the time of day, the date, whether alternate routes are available, etc., and may change during the call. In addition, the SS 321 may use IP multicasting or other technologies to efficiently route the call among multiple devices.

Although FIGS. 5 and 6 do not illustrate data flows passing through the DSN 316, 328, those of skill in the art will recognize that the SS 321 can route media through the DSNs in the same manner as through the MGs 318, 330. For purposes of convenience and clarity, this description uses the term “call” to refer to communications using traditional voice paths and communications utilizing data paths (e.g., communications passing through the DSN 316, 328).

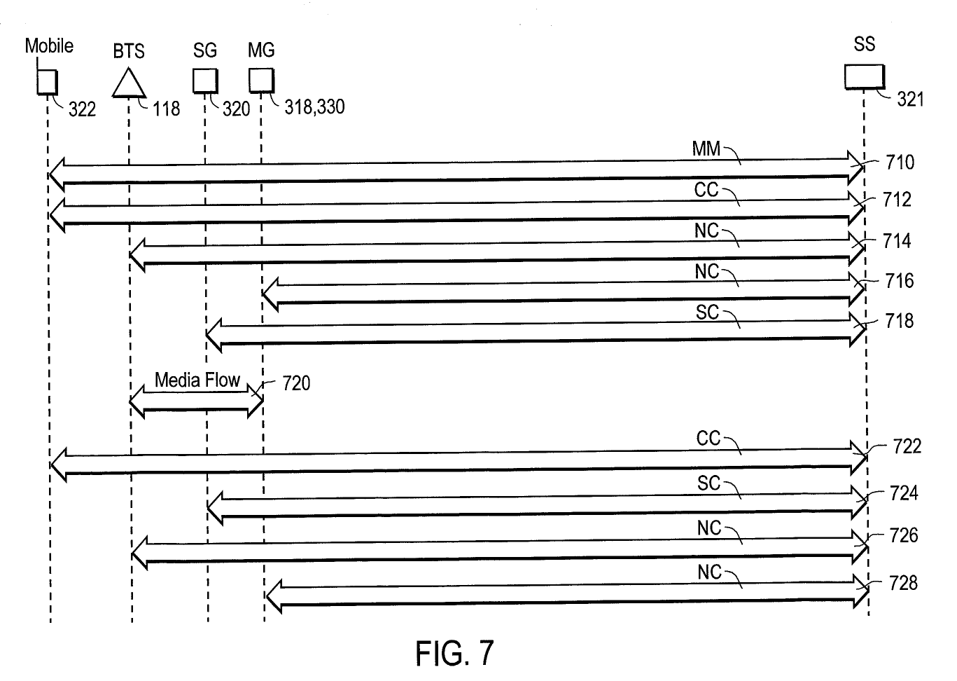

FIG. 7 is a ladder diagram illustrating the functions performed by the SS 321 to process a call. Specifically, FIG. 7 illustrates how the SS 321 processes a call originated by a mobile device 322 at an enterprise 112 and directed to a device on the PSTN 122 or PLMN 120. The top of FIG. 7 illustrates some of the devices involved in processing the call, including the mobile device 322, BTS 118, SG 320, MG 318, 330 (representative of the MG in the enterprise 112 or the MG in the NOC 110), and the SS 321. Arrows are shown below the devices and represent communications between the SS 321 and another device, as indicated by the alignment of the arrows. Time flows from top to bottom, and each arrow represents a step of the call processing. Those of skill in the art will recognize that FIG. 7 illustrates a high-level abstraction of the steps and that the illustrated steps may require multiple sub-steps and/or message exchanges. In addition, embodiments of the present invention may perform the described steps in different orders, omit certain steps, and/or include additional steps.

At the initiation of a call, the SS 321 communicates 710 with the mobile device 322 (through the BTS 118) to perform mobility management (MM). In general, MM is the process of recognizing the mobile device 322 and establishing parameters for use during the call. MM includes functions such as identifying and authenticating the mobile device 322 and setting up any encryption or anonymity functions. The SS 321 also communicates 712 with the mobile device 322 through the BTS 118 to perform call control (CC). CC is the process of establishing a relationship with the calling device to set up the call. Both MM and CC preferably occur via the base station control interface 418.

The SS 321 preferably communicates 714 with the BTS 118 to perform network control (NC). NC sets up the network to serve the call. For example, NC involves establishing a media flow path from the BTS 118 to the MG 318, 330 (if the call is answered), playing announcements and tones, etc. At approximately the same time, the SS 321 preferably also communicates 716 with the MG 318, 330 to perform NC. Both of these communications preferably occur over the media control interface 416. While doing NC, the SS 321 also communicates 718 with the SG 320 via the signaling control interface 420 to perform signaling control (SC). SC communicates with the PSTN 122 or PLMN 120 to establish the call.

After the call is established, the media flow occurs 720 via one of the previously-described paths. Once the call ends, the SS 321 terminates the call by communicating with the mobile device 322, BTS 118, SG 320, and MG 318, 330 to perform CC 722, SC 724, and NC 726, 728.

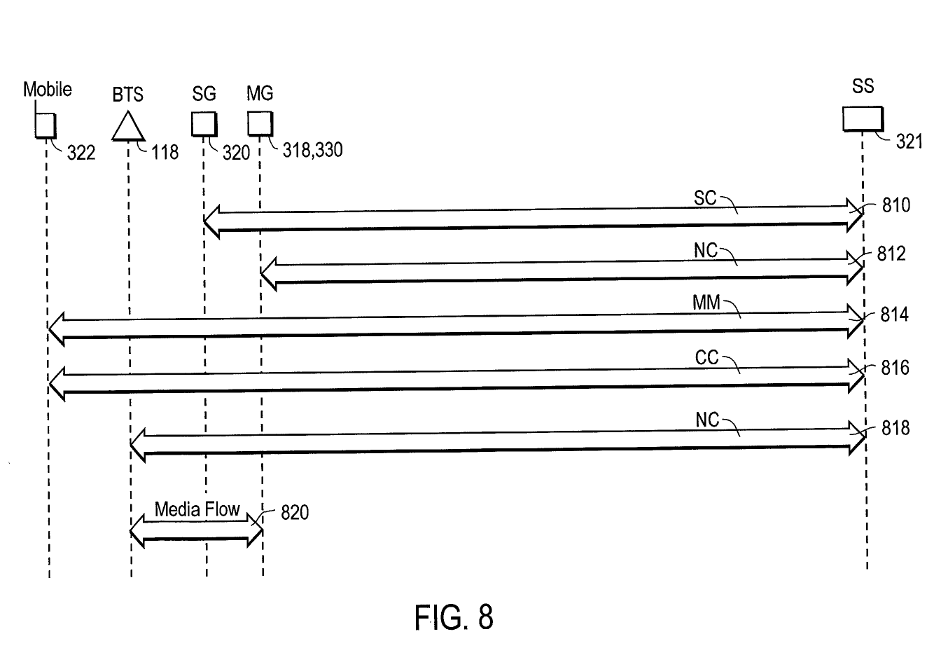

FIG. 8 is a ladder diagram illustrating the steps performed by the SS 321 to process a call initiated by a device on the PSTN 122 or PLMN 120 and directed to a mobile device 322 at an enterprise 112. FIG. 8 is generally similar to FIG. 7. Those of skill in the art will recognize that FIG. 8 illustrates a high-level abstraction of the steps and that the illustrated steps may require multiple sub-steps and/or message exchanges. In addition, embodiments of the present invention may perform the described steps in different orders, omit certain steps, and/or include additional steps.

Since the call originates on an external network, the SS 321 initially receives 810 messages from the SG 320 for performing SC. In response, the SS 321 communicates 812 with the MG 318, 330 to perform NC for the incoming call. The SS 321 communicates 814, 816 with the BTS 118 and mobile device 322 to perform MM and CC. Then, the SS 321 communicates 818 with the BTS 118 to perform NC. After the call is answered, media flows 820 on a path between the BTS 118 and the MG 318, 330. Although the call termination is not shown in FIG. 8, it will be appreciated by one of skill in the art that it is generally similar to the termination illustrated in FIG. 7. Furthermore, although FIGS. 7 and 8 do not show call processing for calls between two mobile devices 322, calls between a mobile device and a device on the PBX 332, or other types of calls, it will be appreciated that the processing is generally similar to that illustrated in FIGS. 7 and 8.

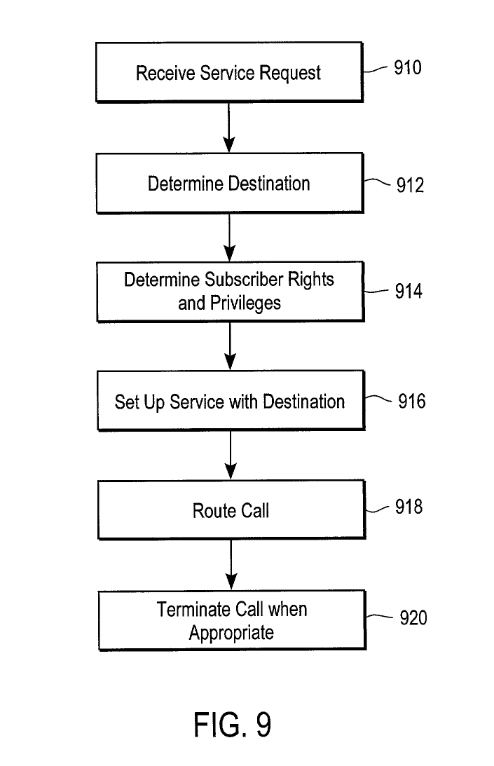

FIG. 9 is a flow chart illustrating steps performed by the SS 321 in combination with other devices in the NOC 110 and/or enterprise 112 to provide enterprise-level enhanced calling features according to an embodiment of the present invention. Those of skill in the art will recognize that the steps of FIG. 9 are high-level abstractions of the functionality described above. The illustrated steps may require multiple sub-steps and/or message exchanges according to the interfaces and protocols described above. In addition, embodiments of the present invention may perform the described steps in different orders, omit certain steps, and/or include additional steps.

Initially, the SS 321 receives 910 a service request from a calling device. The calling device can be a mobile device 322 at the enterprise 112, a device on the enterprise's PBX 326, a server on the Internet 124, a device on the PSTN 122, or a mobile device on the external PLMN 120. The SS 321 determines 912 the destination of the service request (i.e., the device being called). For example, the called device may be a mobile device 322 at the enterprise, a device on the PBX, a device on the PSTN 122, a device on the Internet 124, or a mobile device on the PLMN 120.

The SS 321 also preferably accesses the profile(s) of the subscriber(s) associated with the mobile device(s) to determine the rights and privileges available to the subscriber(s). For example, the SS 321 may determine whether the subscriber utilizing the calling and/or called device is entitled to access certain enhanced calling features. Thus, if the call is from a mobile device 322 at the enterprise 112 and seeks to create a conference call with other devices, the SS 321 determines whether the subscriber utilizing the mobile device is entitled to access conference call functionality. Similarly, if the call is from an external device on the PSTN 122 or PLMN 120 and the called device is a mobile device 322 at the enterprise 112, the SS 321 may determine whether the subscriber using the called device is entitled to access call waiting, call forwarding, concurrent ringing, and/or other enhanced calling features.

The SS 321 sets up 916 the requested service with the destination device as illustrated in FIGS. 7 and 8. This step can fail if the destination device is unavailable or otherwise unable to take the call (this occurrence is not illustrated in FIG. 9).

The SS 321 routes 918 the media flow for the call on a path from the calling device to the called device. In a preferred embodiment, the SS 321 performs this routing by controlling the devices in the enterprise 112 to send the call traffic point-to-point across the enterprise's IP network 116 as illustrated in FIGS. 5-6. The SS 321 also performs the appropriate handoffs should the mobile device 322 at the enterprise 112 move between coverage areas. Eventually, the SS 321 terminates 920 the call in response to a message from the called or calling device.

In sum, the present invention provides enhanced calling features to mobile devices in the enterprise in a cost-effective manner. The present invention also allows advanced calling features to span both wireless and wired networks and efficiently routes media flows for calls. Call processing and other network control is provided from a centralized SS 321, which allows the cost of the service to be amortized over many more subscribers than would be possible if each enterprise required its own SS. Plus, the BTSs 118 are connected directly to the enterprise's IP network 116, eliminating the need for the enterprise to install a costly dedicated infrastructure. The BTSs 118 can also be configured remotely by devices on the NOC 110, rather than requiring on-site configuration.

The above description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed by the spirit and scope of the invention.

We claim:

1. A network operation center (NOC) in a telecommunications system, comprising:
a NOC network for supporting communications with one or more remote enterprises, each enterprise including at least one base transceiver station (BTS) for interfacing with mobile devices at the enterprise; and
a softswitch in communication with the BTSs at the remote enterprises via the NOC network for providing communications capabilities to the mobile devices at the enterprises.

2. The NOC of claim 1, wherein the NOC is in communication with one or more other NOCs via a wide area network.

3. The NOC of claim 1, wherein an enterprise further comprises:
an enterprise internet protocol (IP) network in data communication with the at least one BTS at the enterprise and the NOC network, the enterprise IP network adapted to provide communications between the softswitch and the at least one BTS.

4. The NOC of claim 1, wherein the softswitch is adapted to connect a call between a first device and a second device, and wherein the softswitch comprises:
a module adapted to cause data representative of control signals to be transmitted among the first device, second device, and softswitch and to cause data representative of call media to be transmitted point-to-point between the first and second devices.

5. The NOC of claim 3, wherein the enterprise further comprises:
a media gateway in data communication with the enterprise IP network, the media gateway adapted to enable communications between mobile devices at the enterprise and other devices in data communication with the media gateway responsive to management from the softswitch.

6. The NOC of claim 5, wherein the softswitch is adapted to connect a call between a first device and a second device, wherein the first device is a mobile device at the enterprise interfacing with a BTS and the second device is on a public telephone network in data communication with the media gateway, and wherein the softswitch comprises:
a module adapted to cause data representative of control signals for the call to be transmitted among the BTS, media gateway, and softswitch and to cause data representative of call media to be transmitted point-to-point over the enterprise IP network between the BTS and the media gateway.

7. The NOC of claim 5, wherein the softswitch is adapted to connect a call between a first device and a second device, wherein the first device is a mobile device at the enterprise interfacing with a BTS and the second device is on a private branch exchange (PBX) network in communication with the media gateway, and wherein the softswitch comprises:
a module adapted to cause data representative of control signals for the call to be transmitted among the BTS, media gateway, and softswitch and to cause data representative of call media to be transmitted point-to-point over the enterprise IP network between the BTS and the media gateway.

8. The NOC of claim 3, wherein the enterprise further comprises:
a data serving node in data communication with the enterprise IP network and an external data network, the data serving node adapted to enable communications between mobile devices at the enterprise and devices on the external data network responsive to management from the softswitch.

9. The NOC of claim 8, wherein the softswitch is adapted to connect a call between a first device and a second device, wherein the first device is a mobile device at the enterprise interfacing with a BTS and the second device is on the external data network, and wherein the softswitch comprises:
a module adapted to cause data representative of control signals for the call to be transmitted among the BTS, data serving node, and softswitch and to cause data representative of call media to be transmitted point-to-point over the enterprise IP network between the BTS and the data serving node.

10. The NOC of claim 1, further comprising:
a feature server in data communication with the NOC network for storing data representative of calling features available to the mobile devices at the enterprises.

11. The NOC of claim 10, further comprising:
a subscriber profile module identifying subscribers associated with the mobile devices at the enterprises and describing calling features available to the subscribers.

12. The NOC of claim 1, further comprising:
an application server in data communication with the NOC network for storing application program modules for providing functionality to the mobile devices at the enterprises.

13. The NOC of claim 1, further comprising:
a data serving node in data communication with the NOC network and an external data network, the data serving node adapted to enable communications between mobile devices at the enterprises and devices on the external data network responsive to management from the softswitch.

14. The NOC of claim 1, further comprising:
a media gateway in data communication with the NOC network and a public telephone network, the media gateway adapted to enable communications between mobile devices at the enterprises and devices on the public telephone network responsive to management from the softswitch.

15. The NOC of claim 1, wherein the softswitch is in data communication with an external public land mobile network (PLMN) and wherein the softswitch is adapted to provide communications capabilities between the mobile devices at the enterprises and devices on the external PLMN.

16. The NOC of claim 1, wherein the communications capabilities include call processing providing enhanced calling features to the mobile devices.

17. The NOC of claim 1, wherein the communications capabilities include mobility management for the mobile devices.

18. A computer program product comprising:
a computer-readable medium having computer program code embodied therein for providing communications capabilities to a plurality of mobile devices at an enterprise remote from a network operations center (NOC), the mobile devices in communication with base transceiver stations (BTSs) at the enterprise, and the BTSs communicating via an enterprise internet protocol (IP) network, the computer program code comprising:
a softswitch module adapted to provide the communications capabilities to the mobile devices, to cause data representative of control signals for providing the communications capabilities to be transmitted among the BTS and the NOC, and to cause data representative of call media to be transmitted point-to-point across the enterprise IP network.

19. The computer program product of claim 18, wherein the softswitch module is adapted to support a plurality of mobile devices at each of a plurality of enterprises.

20. The computer program product of claim 18, wherein the softswitch module is adapted to establish flow paths on the enterprise IP network for the data representative of call media.

21. The computer program product of claim 18, wherein the enterprise IP network is in data communication with an external public land mobile network (PLMN) and wherein the communications capabilities provided by the softswitch module include mobility management.

22. The computer program product of claim 18, wherein each mobile device is associated with a subscriber, wherein the softswitch module is adapted to access data representative of enhanced calling features available to the subscribers associated with the mobile devices, and wherein the communications capabilities provided by the softswitch module include the enhanced calling features.

23. The computer program product of claim 18, wherein a media gateway is in data communication with the enterprise IP network and wherein the softswitch module is adapted to interface with a media gateway to provide communications capabilities between the mobile devices at the enterprise and devices behind the media gateway.

24. The computer program product of claim 23, wherein the media gateway is in communication with a private branch exchange at the enterprise and wherein the softswitch module is adapted to interface with the media gateway to provide communications between the mobile devices at the enterprise and devices on the private branch exchange.

25. The computer program product of claim 23, wherein the media gateway is in communication with a public switched telephone network (PSTN) and wherein the softswitch module is adapted to interface with the media gateway to provide communications between the mobile devices at the enterprise and devices on the PSTN.

26. A method of providing communications capabilities to mobile devices at a remote enterprise, the remote enterprise including at least one base transceiver station (BTS) for interfacing with the mobile devices at the enterprise, the method comprising the steps of:
providing a network operations center (NOC) network for supporting communications with the remote enterprise; and
providing a softswitch in communication with the BTS at the remote enterprises via the NOC network, the softswitch for providing the communications capabilities to the mobile devices at the enterprise.

27. The method of claim 26, wherein the enterprise further includes an enterprise internet protocol (IP) network in data communication with the at least one BTS at the enterprise and the NOC network, the enterprise IP network providing communications between the softswitch and the at least one BTS.

28. The method of claim 27, wherein the softswitch is adapted to connect a call between a first device and a second device, and is further adapted to cause data representative of control signals to be transmitted among the first device, second device, and softswitch and to cause data representative of call media to be transmitted point-to-point between the first and second devices.

29. The method of claim 26, wherein the softswitch is adapted to connect a call between a mobile device at the enterprise and a second device via a media gateway.

30. The method of claim 26, wherein the softswitch is adapted to connect a call between a mobile device at the enterprise and a second device via a data serving node.

31. The method of claim 26, further comprising the step of:
providing a feature server in data communication with the NOC network for storing data representative of enhanced calling features available to the mobile devices at the enterprise.

32. The method of claim 31, further comprising the step of:
providing a server adapted to store subscriber profiles identifying subscribers associated with the mobile devices at the enterprise and describing the enhanced calling features available to the subscribers, wherein the communications capabilities provided by the softswitch include the enhanced calling features.

33. The method of claim 26, further comprising the step of:
providing an application server in data communication with the NOC network for storing application program modules for providing functionality to the mobile devices at the enterprise.

34. The method of claim 26, further comprising the step of:
providing a data serving node in data communication with the NOC network and an external data network, the data serving node adapted to enable communications between mobile devices at the enterprise and devices on the external data network responsive to management from the softswitch.

35. The method of claim 26, further comprising the step of:
providing a media gateway in data communication with the NOC network and a public switched telephone network (PSTN), the media gateway adapted to enable communications between mobile devices at the enterprise and devices on the PSTN responsive to management from the softswitch.

36. The method of claim 26, wherein the softswitch is in data connection with an external public land mobile network (PLMN) and wherein the softswitch is adapted to provide communications capabilities between the mobile devices at the enterprise and devices on the PLMN.

37. The method of claim 26, wherein the communications capabilities provided by the softswitch include call processing providing enhanced calling features to the mobile devices.

38. The method of claim 26, wherein the communications capabilities provided by the softswitch include mobility management for the mobile devices.

39. The method of claim 26, wherein a mobile device communicates with the BTS via Bluetooth.
